(19) United States
(12) Patent Application Publication
(10) Pub. No.: US 2012/0059703 A1
(43) Pub. Date: Mar. 8, 2012

(54) ORDERING PERSONALIZED ITEMS WITH GIFT DELIVERY

(76) Inventor: Flint Mc Coy, Costa Mesa, CA (US)

(21) Appl. No.: 12/876,068

(22) Filed: Sep. 3, 2010

(51) Int. Cl. G06Q 30/00

(52) U.S. Cl. 705/14.23; 705/14.4

(57) ABSTRACT

A system provides for a centralized service adding an electronic media player to a floral delivery order. A prerecorded song, still or moving image can be customizably loaded on to the player. As well, audio, still, and moving images can be uploaded by the person placing the order with a centralized service. The order is relayed to a local florist for delivery. Local merchants can register offers with the centralized service to be presented as options for the orderer. Some offers such as discount offers, can defray the expense of the media player to the orderer. Other offers, gift certificates, for example, could be chosen that would add to the cost of the overall delivered package.

### FIELD

The technology presented herein is within the field of on-line ordering of personalized items and targeted advertising.

### BACKGROUND

Ordering flowers to be delivered to another person at a remote location is well known and has been done by telegraph, telephone, email, and by other internet methods. Generally a floral arrangement is chosen and possibly a card with a personalized greeting is also ordered. To supplement this basic service it is known to have a “singing telegram” delivery person and some have suggested essentially an automated singing telegram implemented as a musical vase or other audio delivery mechanisms. Unfortunately these services are not widely offered, possibly due to the added cost of a single-use high quality audio player. Also, it could possibly be due to the low quality of an audio player. A low quality audio player (like that in some musical greeting cards) can negatively affect the experience of receiving flowers. Delivering a favorite song, a photo, or other personalization could enhance the experience of receiving flowers if done in a manner of a reasonable cost to the purchaser.

### SUMMARY

In various embodiments of systems, devices, and methods of this disclosure, a small electronic apparatus can be delivered along with a delivered gift item. The apparatus can be small and water-resistant and can be attached to a vase or directly to a bouquet of flowers. Some devices can have an MP3 audio player containing a single song. Others may have a small still or video image player. The cost of the devices and songs can be offset in some embodiments by incorporating local advertising into a gift ordering system.

In some embodiments the person doing the ordering is offered the opportunity to include discount coupons to businesses local to the recipient. Accepting these could lower the orderer's cost for the gift and music player due to underwriting by the local businesses. In some cases the orderer might add a gift certificate to a local business, possibly at an increase in cost.

### BRIEF DESCRIPTION OF THE DRAWINGS

FIG. 1 shows a schematic diagram of the operations of ordering and delivering flowers plus ancillary, personalized items;

FIG. 2 is a flowchart of the steps taken by a central flower ordering system;

FIG. 3 is a flowchart of the steps taken by the person doing the ordering;

FIG. 4 is a flowchart of the steps taken by a local florist.

### DETAILED DESCRIPTION

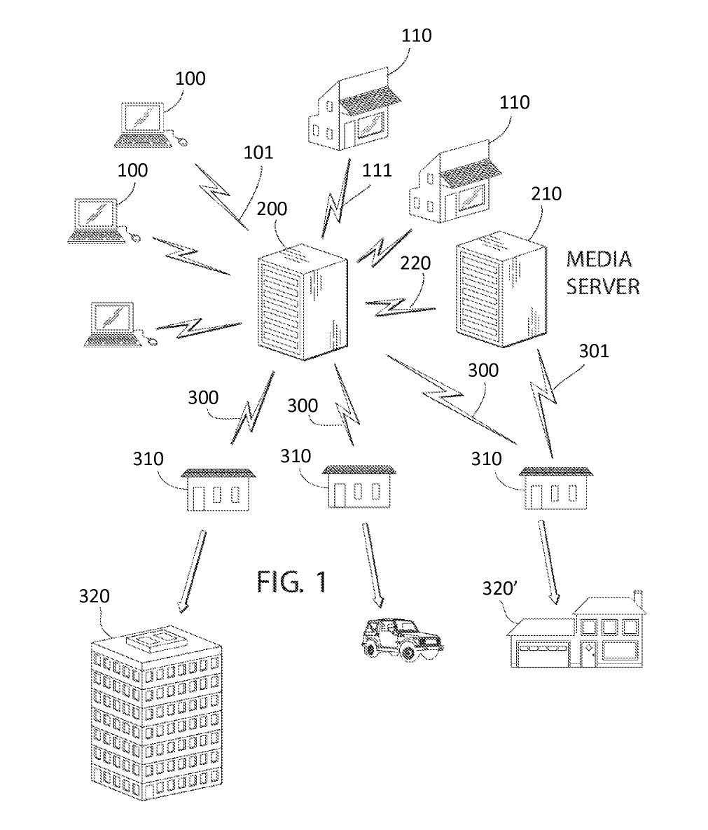

In one embodiment portrayed in FIG. 1, a central floral ordering system 200 is in communication with several other systems and people at a variety of physical locations. Orderers 100 communicate 101 with the floral ordering system over the internet. In turn the ordering system communicates 300 with geographically dispersed local florists 310. The local florists manage the requested deliveries to the locations' of the recipients 320 320′.

Also in this overall scheme are local retail businesses 110. They communicate 111 with the central floral ordering system 200. This communication involves placing two types of offers on that system. One type is a discount or rebate to the orderers intending to have items delivered to recipients proximate to a respective local business. In return for including an advertisement, a discount coupon with the floral delivery, the local business defrays part of the cost of the order.

An additional type of offer a local merchant could place on the central ordering system can be a gift certificate. In that case, the orderer would most likely have an additional cost rather than a reduced cost.

Another aspect to this overall system is a media server 210. While ordering flowers, a purchaser can also chose from several optional personalized content to be hand delivered. One is a small electronic player that can hold a single song. It can be integral to a vase or it can be a unit that is attachable to a vase or directly to a bouquet of flowers. A player might also have a screen that can show a still or a moving image selected or uploaded by the purchaser. Other options can include a printed message.

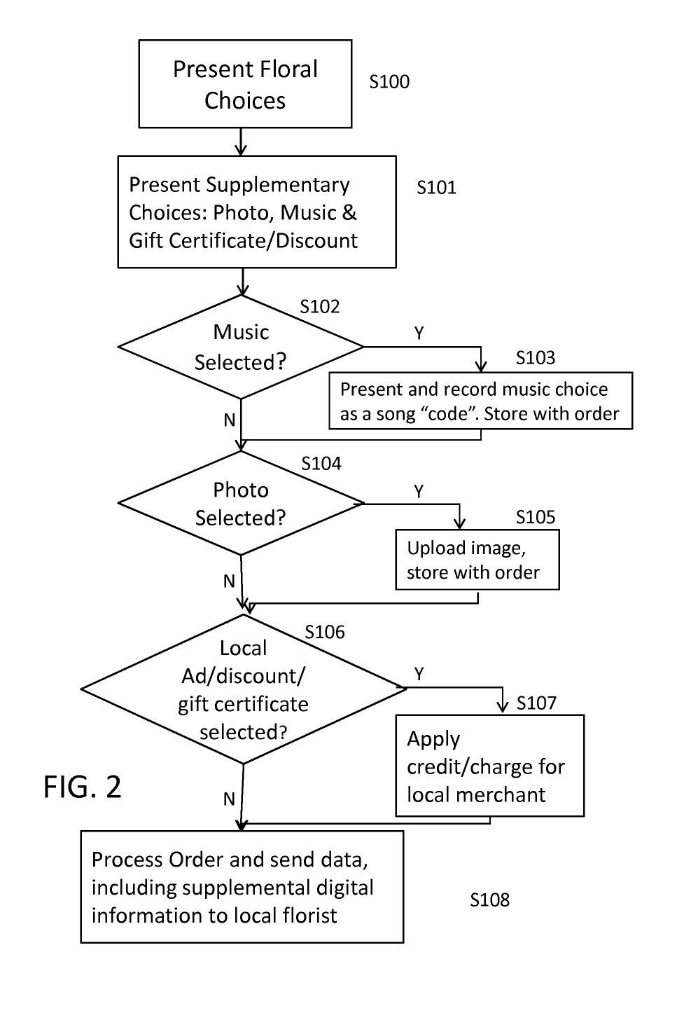

The actions taken by the central ordering system are outlined in the flowchart of FIG. 2. To an interactive user, the system would present floral choices S100. Also presented are complimenting personalized items including a song, a professional image or video clip and the option of uploading an image or video clip. S101. A concern of the orderer may be that including an electronic player would increase cost to the orderer. These teachings provide for underwriting part of that increased cost via advertising. Therefore the system also can present the option of a discount coupon or other promotional message from a business local to the recipient along with the flowers and song S101.

If music is desired S102, selections can be presented S103. The selection might be customized for the time of year, the type of flowers being ordered, or on another basis. In a similar manner an image may be selected S104 and if requested, chosen from a stock database, or uploaded by the orderer. Another step is presenting the option of including a commercial message, offer, or gift certificate S106. If chosen, the options available in the locale of the recipient are presented S107.

When all options have been presented the ordering system processes the order S108 and transmits the relevant information to a local florist. This may include a code for a song that the local florist uses to communicate directly 301 with a media server 210. Alternatively it might include a digital file of the song along with the other order information sent by a path 300 over the internet.

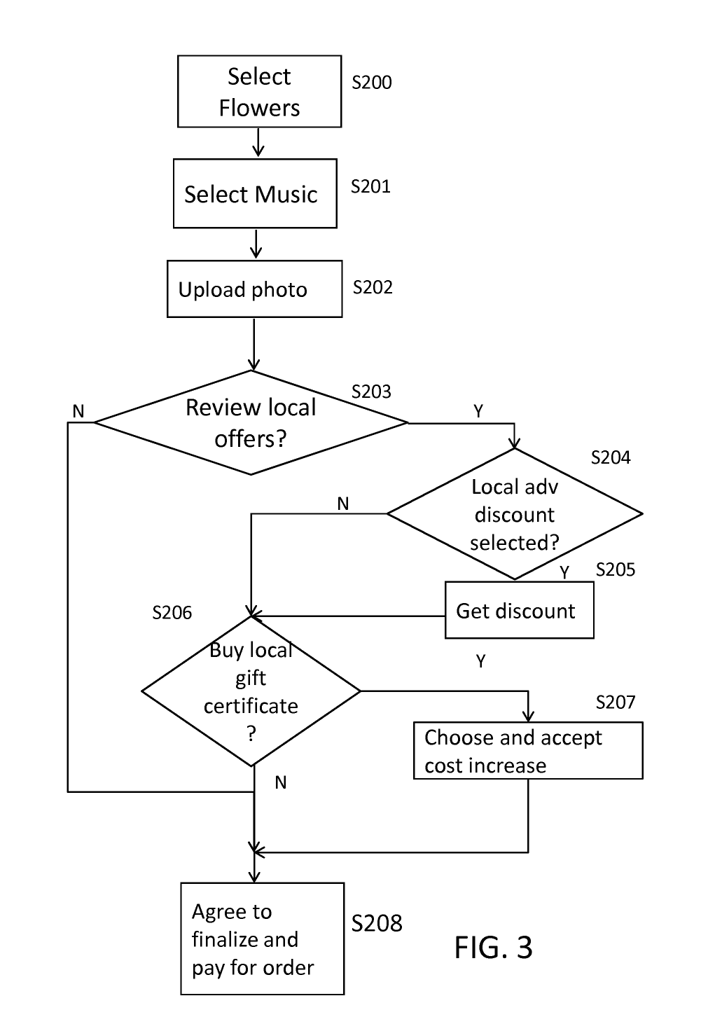

As performed by the user or order-placing individual, the steps involved are those of FIG. 3. The user goes through the various screens and decisions S200 S201 S202 presented by an interface module, leading up to deciding to include a local business offer or not S203. If so, the options may include getting a discount by including some offers S204 S205 and paying an additional amount for choosing other options S206 S207. When completed, the user finalizes their order and pays S208. This can be accomplished by a transaction module.

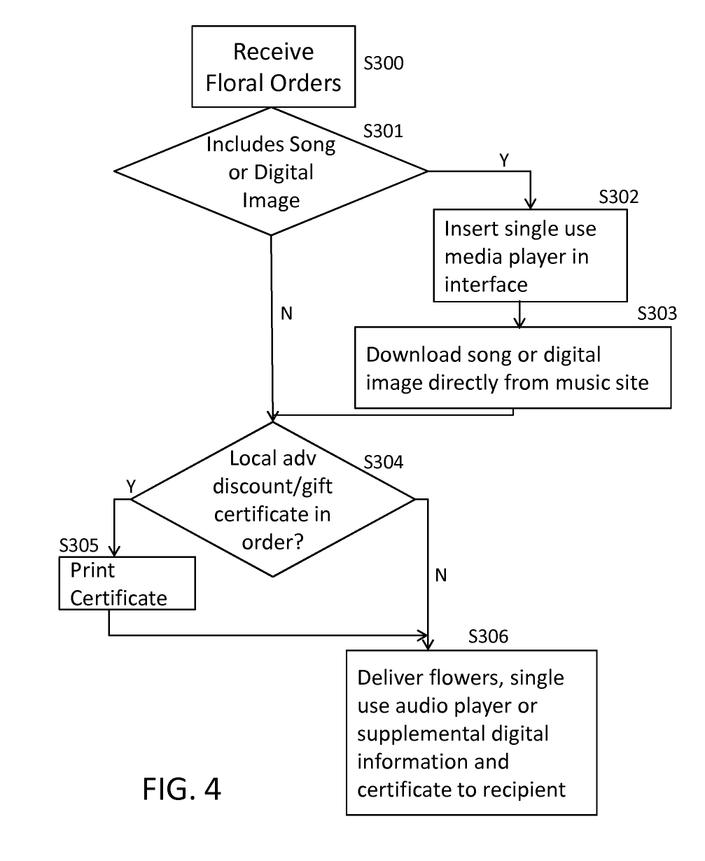

A participating local florist receives orders S300 from the central floral system as shown in the flowchart of FIG. 4. If the order includes a song or a digital image S301, the florist places S302 a small media player in an interface cradle connected to their computer. As an integral part of receiving the order, the chosen song or image is downloaded into that media player. A song or professionally produced image can come from the floral system 200 or can come directly S303 from a media server 210 as diagramed in the flowchart of FIG. 4. The media server may be a facility of the rights-holder for that material or a server of an intermediary. The media might be transferred to the player wirelessly using Bluetooth, WiFi, or other suitable technology.

In addition, the order may include an offer from a local merchant S304. Physically, that may be embodied as a file sent with the order that is printed out S305 by the florist or might be something locally provided and stocked by the florist. One possibility is a media player with a specific imprinted or digital message. A gift certificate might be in the form of a digital image, message, audio or video content 105 loaded onto a media player rather than a paper certificate. In that case, the gift recipient redeems the “gift certificate” by presenting the media player containing the offer. The local establishment might accept (and cancel) the certificate by deleting it from the player. This could be done by pushing a small button or might be done wirelessly.

Also, the orderer may have composed a personal message to be printed out by the florist and included in the delivery. The florist shop assembles the floral item or other gift and the selected supplementary items and delivers S306 them to the recipient's location 320 320′. The group of items to be delivered to a recipient can be called a gift set.

Although the above described example systems used a floral delivery service, the teachings herein are applicable broadly to locally delivered gift items. Some examples are candy, edible arrangement, fruit basket, and wine.

The various illustrative program modules and steps described in connection with the embodiments disclosed herein may be implemented as electronic 120 hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, 125 the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and 130 a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD 135 or any other form of tangible storage medium known in the art. An exemplary processor may be coupled to the storage medium so as to read information from, and write information to, the storage medium. In the alternative, the storage medium may be integral to the processor.

In further embodiments, those skilled in the art will appreciate that the 140 foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine- readable data storage media, such as a conventional “hard drive”, 145 magnetic tape, electronic read-only memory (e.g., ROM or EEPROM), flash memory, an optical storage device (e.g., CD, DVD, digital optical tape), or other suitable data storage media.

This description, figures and examples are intended to be non-limiting and to teach the principles and use of the invention. The claims below, in contrast, set out 150 its metes and bounds. In the claims, the words “a” and “an” are to be taken to mean “at least one” even if some claim wording explicitly calls for “at least one” or “one or more”.

Those skilled in the art will be aware of materials, techniques and equipment suitable to produce the various example embodiments presented as well as 155 variations on those examples. This teaching is presented for purposes of illustration and description but is not intended to be exhaustive or limiting to the forms disclosed. Many modifications and variations will be apparent to those of ordinary skill in the art. The embodiments and versions help to explain the principles of the invention, the practical application, and to enable others of ordinary skill in the art 160 to understand it. Various embodiments with various modifications as are suited to the particular application contemplated are expected.

In the following claims, the words “a” and “an” should be taken to mean “at least one” in all cases, even if the wording “at least one” appears in one or more claims explicitly. The scope of the invention is set out in the claims below.

What is claimed:

1. A method of ordering a gift item for remote delivery to a recipient using a computer system with a processor and memory, comprising:
a. providing a choice of gift items to be delivered;
b. providing a music choice to be delivered on an electronic media player;
c. providing choice of a commercial message from a third party to be delivered;
d. accepting a choice of a commercial message of a third party to be delivered to the recipient;
e. changing the price of the bundle of items to be delivered by an amount effectively predetermined by the third party;
f. transmitting the order such as to be accessible from a physical location proximate to the location of the recipient.

2. The method of claim 1 wherein the price changing is a price reduction in return for the commercial message inclusion in the delivery to the recipient.

3. The method of claim 1 wherein the commercial message is a gift certificate and the price change is an increase in price in return for value represented by the certificate.

4. The method of claim 3 wherein the gift certificate is substantially embodied as a first media content loaded onto a stand-alone media player.

5. The method of claim 4 wherein redeeming the gift certificate comprises deleting the first media content from the media player.

6. The method of claim 1 further comprising uploading an image file to be loaded onto the electronic media player prior to its delivery.

7. The method of claim 1 wherein the choice of gift items comprise floral items.

8. The method of claim 7 wherein the computer system comprises a network interface module.

9. A method of receiving a gift item order on a computer system having a processor and a memory, comprising:
receiving, electronically, a delivery order including:
a. a designation of a specific gift item;
b. a commercial message to be contemporaneously derived;
c. a recipient's physical location information.

10. The method of claim 9 wherein the delivery order further includes a designation of a song to be delivered installed on a media player.

11. The method of claim 10 wherein the song is automatically loaded onto a media player from the computer system.

12. The method of claim 9 wherein the specific designated gift item comprises a floral item.

13. The method of claim 12 wherein electronically receiving substantially comprises receiving over the internet.

14. The method of claim 9 further comprising: preparing the specific gift item, the designated song, and the commercial message for physical delivery to the recipient's location.

15. The method of claim 11 wherein the commercial message comprises a gift certificate substantially in the form of media content loaded onto the media player.

16. The method of claim 15 wherein the media content is readily disable-able.

17. A system for processing orders for a gift set to be delivered to a specific person comprising:
a) an interface module executing on a computer system providing an orderer with:
i) a choice of gift items;
ii) a choice of digital audio, or optionally digital image content;
iii) a choice of commercial offers to be delivered with the chosen gift item;
b) a transaction module executing on a computer system for processing choices, totaling costs, confirming payment, and creating a digital data record representative of the gift set;
the cost totaling such that the cost of a gift set is reduced by the orderer's choice to include a commercial offer in the gift set.

18. The system of claim 17 further comprising a digital communication module for communicating the orderer's choices to a remote location for delivery.

19. The system of claim 18 wherein the digital communication module and the user interface module execute on a computer system having a processor, a memory, and a network interface system.

20. The system of claim 17 further comprising a media communication module for communicating with a 3^{rd} party media server.
